(19) United States
(12) Patent Application Publication
(10) Pub. No.: US 2013/0193926 A1
(43) Pub. Date: Aug. 1, 2013

(54) Battery System and Method for Charging a Large Number of Battery Cells which are Connected in Series

(71) Applicants: Christian Kluthe, Filderstadt (DE); Francois Mothais, Stuttgart (FR); Frank Heitkaemper, Leutenbach (DE); Robert Thomas, Stuttgart (DE)

(72) Inventors: Christian Kluthe, Filderstadt (DE); Francois Mothais, Stuttgart (FR); Frank Heitkaemper, Leutenbach (DE); Robert Thomas, Stuttgart (DE)

(73) Assignees: Samsung SDI Co., Ltd., Yongin-si, Gyeonggi-do (KR); Robert Bosch GmbH, Stuttgart (DE)

(21) Appl. No.: 13/813,947

(22) PCT Filed: Jun. 7, 2011
(86) PCT No.: PCT/EP2011/059361

§ 371 Date: Apr. 15, 2013

(30) Foreign Application Priority Data
Aug. 4, 2010 (DE) 10 2010 038 882.3

(51) Int. Cl. H01M 10/48; H02J 7/00

(52) U.S. Cl. CPC H01M 10/482; H02J 7/0052
USPC 320/122; 429/93

(57) ABSTRACT

The disclosure describes a battery system having a large number of battery cells which are connected in series. At least one battery cell of the large number of battery cells is connected in parallel with an electrical component. The resistance of the electrical component is reduced when a voltage, which is applied to the electrical component and to the battery cell, exceeds a predetermined voltage threshold value. The disclosure also describes a method for charging a large number of battery cells which are connected in series. The method can be executed using the battery system according to the disclosure.

The present invention relates to a battery system, a motor vehicle having the battery system according to the invention and a method for charging a multiplicity of battery cells connected in series.

### PRIOR ART

Lithium-ion technology can be used to produce very powerful batteries which have higher energy densities than those produced using other battery technologies. Furthermore, lithium-ion batteries do not suffer from a loss of capacity known as memory effect. One of the few disadvantages of lithium-ion battery cells, on the other hand, is their susceptibility to overvoltage, which occurs at cell voltage values of typically more than 4.2 V. In the case of overvoltage, metallic lithium is deposited on the anode, as a result of which the cathode material becomes the oxidizing element and loses is stability. This causes the battery cell to heat to a greater and greater extent and in extreme cases to catch fire (what is known as a thermal runaway). Particularly in the case of a battery pack, which in the case of applications in an electric vehicle is constructed from approximately one hundred single cells connected in series, it is absolutely necessary to avoid overvoltages, since thermal runaway in an individual cell would trigger a cascade reaction within the whole battery pack.

In order to avoid thermal runaway, the voltages of the single cells which the lithium-ion battery packs contain are monitored by means of special control circuits. In this case, a control circuit can monitor up to twelve battery cells. If an overvoltage occurs on one of the battery cells in the course of the battery pack being charged, the battery management system comprising the control circuits momentarily opens a high voltage contactor and interrupts the charging process for the whole battery pack. Although this approach ensures that the battery pack is safe, it has a number of disadvantages.

By way of example, the provision of evaluation electronics on the control circuits is associated with relatively high costs. Furthermore, the charging process is interrupted for all of the battery cells and not just for that battery cell which has an increased voltage. Merely short, noncritical voltage spikes, which are caused by a DC chopper, a charger or an electric motor in the electric vehicle being switched on or off, for example, entail disconnection of the battery, which can result in the electric vehicle not being able to travel further, for example. In addition, the previous design is not suitable for the use of inexpensive, single-phase chargers, since these produce a large sinusoidal current ripple and hence also a corresponding voltage ripple, which can result in disconnection of the battery before it is fully charged. Finally, use of the conventional method leads to the usable capacity of the battery pack being restricted, since the cell voltage is higher than the quiescent voltage for the duration of the charging process, said quiescent voltage defining the relevant charge state. If charging is aborted on account of an overvoltage infringement, the battery cell is at this time still not charged in line with its total capacity.

Besides monitoring the cell voltage, the control circuits have the task of aligning the voltages of the battery cells. This is necessary in order to avoid a situation in which some battery cells are already at a charge state of 100% and hence close to the overvoltage disconnection limit while the majority of the remaining battery cells still have charge states significantly below 100%. Without phases of charge equalization between the charging phases, the usable capacity of the battery pack would therefore be much lower than the sum of the usable capacities of the single cells. Hitherto, charge equalization (what is known as cell balancing) for the cells is therefore performed before or between charging phases, this involving each of the battery cells at maximum charge being discharged via a resistor to the control circuits until all the battery cells have approached the charge state of the cell with the lowest charge. Although this strategy that has been used hitherto ensures charge equalization for cells, it is also linked to a few disadvantages.

Besides the relatively high costs—which must again be criticized—for the evaluation electronics on the control circuits, the inhomogeneous temperature distribution in the battery pack is disadvantageous, said inhomogeneous temperature distribution being attributable to the fact that the heat produced is dissipated centrally to the control circuits. Furthermore, the charge equalization takes up a relatively long period of time, since it can only ever take place on a small number of battery cells of the battery pack at the same time (typically only one of twelve battery cells can be discharged via a resistor to a control circuit at a given time), and only in alternation with quiescent phases for battery state detection.

### DISCLOSURE OF THE INVENTION

The invention provides a battery system having a multiplicity of battery cells connected in series, in which at least one battery cell has an electrical component connected in parallel with it. The resistance of the electrical component decreases when a voltage across the electrical component and across the battery cell together exceeds a predetermined voltage threshold value.

The battery system is preferably a lithium-ion battery system.

The battery system according to the invention has the advantage that no kind of intelligence or software is required in order to rate the voltage across the battery cell. Using inexpensive electrical components having the desired properties, it is possible to perform a robust method for charge equalization between the battery cells in the battery system according to the invention while simultaneously avoiding overvoltages in said battery cells. The usable capacity of the battery cells connected in series is equal to the sum of the individual cell capacities. Furthermore, a charging process performed in the battery system according to the invention is robust in the face of voltage spikes, which means that said charging process can also be performed without any problems by using single-phase chargers. Since the charging process produces heat over all the electrical components used, the temperature distribution in the battery system is more uniform than in the systems known from the prior art. Finally, the duration of the charging process and of the charge equalization is relatively short, since charge equalization can take place simultaneously for all battery cells in which an appropriate electrical component having the desired properties is connected in parallel.

It is preferred that each of the multiplicity of battery cells has a respective electrical component connected in parallel with it, the resistance of which decreases when a voltage across the electrical component and across the battery cell connected in parallel therewith exceeds the predetermined voltage threshold value.

The resistance of the electrical component can fall exponentially above the predetermined voltage threshold value as the voltage present rises.

The electrical component may be a Zener diode. However, other implementations are also possible, for example using a suppressor diode, also known as a TVS (Transient Voltage Suppressor) diode, or a metal oxide varistor. The characteristic curves of these components have similar properties to those of the Zener diode. Combinations of said components and transistors are also possible.

A further aspect of the invention relates to a motor vehicle which comprises the battery system according to the invention, wherein the battery system is connected to a drive system of the motor vehicle.

A further aspect of the invention relates to a method for charging a multiplicity of battery cells connected in series, in which the multiplicity of battery cells connected in series are supplied with a charging current during a charging process and in which a current flowing through one of the multiplicity of battery cells is suppressed when a voltage across the battery cell exceeds a predetermined voltage threshold value. When the voltage threshold value is exceeded the resistance of an electrical component connected in parallel with the battery cell decreases, with the result that some of the charging current flows through the electrical component.

The method according to the invention has the advantage that charging the battery cells is simplified in comparison with the prior art. In particular, the multiplicity of battery cells can be charged fully using a constant charging current in what is known as a CC (constant current) charging phase without overvoltages being able to arise in the battery cells, while at the same time charge equalization between the battery cells takes place.

In this case, the charging process proceeds as follows: first of all, battery cells having slightly different charge states are charged until those battery cells having the highest charge state have reached the voltage threshold value (for example the breakdown voltage of a Zener diode). In these battery cells, there is then a rapid decrease in the resistance of the electrical component, which routes an ever greater proportion of the charging current past to the battery cells with a high charge state, as a result of which these are charged to a lesser degree than those with a lower charge state. The parallel connection of the electrical component therefore has the effect of a bypass circuit.

As charging continues, the charging current in the battery cells with a charge state of almost 100% comes to a standstill, since the charging current is being routed almost completely through the bypass circuit produced by the electrical component, while the remaining battery cells continue to be charged until their bypass circuits prevent further charging.

Upon conclusion of the charging process, all the battery cells are fully charged without the need for further charge equalization between them.

Throughout the charging process, it is not possible for any overvoltages to occur in a battery cell, since the resistance of the bypass circuit becomes exponentially lower, and hence diverts all of the charging current, as the voltage increases.

### DRAWINGS

Exemplary embodiments of the invention are explained in more detail with reference to the drawings and by means of the description below. In the drawings:

FIG. 1 shows a battery system based on a first embodiment, and

FIG. 2 shows a characteristic curve for a Zener diode which is arranged in the battery system based on a first embodiment.

### EMBODIMENTS OF THE INVENTION

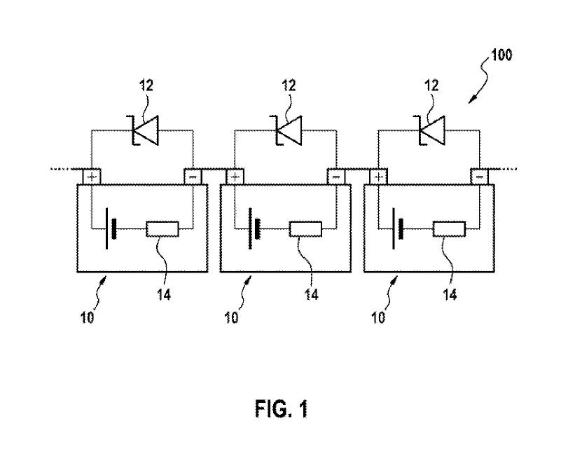

FIG. 1 shows a battery system 100 based on a first embodiment of the invention. The battery system 100 comprises a multiplicity of battery cells 10 connected in series which each have an internal resistance 14. Each battery cell 10 has a respective Zener diode 12 connected in parallel with it, the Zener diode 12 being connected in the reverse direction in respect of a polarity of the battery cells 10 which are shown in FIG. 1.

The Zener diode 12 connected in parallel with a particular battery cell 10 performs the function of a bypass circuit which is activated as soon as the cell voltage of the battery cell 10 exceeds a certain voltage threshold value during a charging process. Once this voltage threshold value has been exceeded, the resistance of the Zener diode 12 falls exponentially as the voltage rises further. Depending on the ratio of the resistance of the Zener diode 12 to the internal resistance 14 of the battery cell 10, an ever greater proportion of a charging current flows via the Zener diode 12, and is thereby routed past the battery cell 10, as the voltage increases.

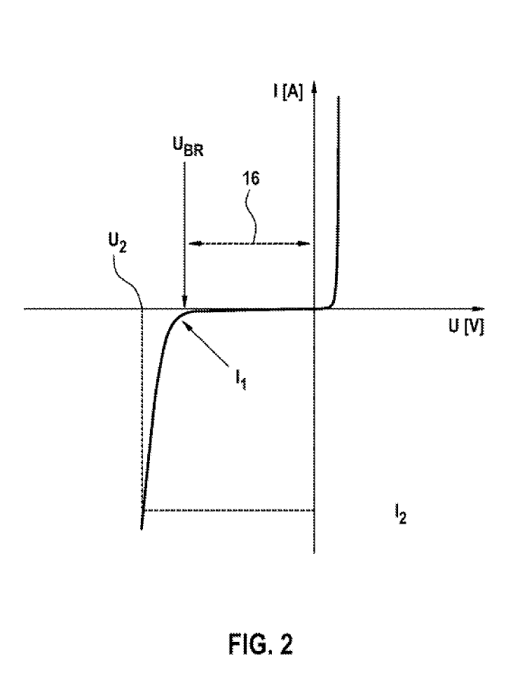

FIG. 2 shows a characteristic curve for one of the Zener diodes 12 shown in FIG. 1. The Zener diode 12 has a very high resistance in an operating range 16 of the cell voltage, as a result of which only a negligibly small leakage current (typically less than 1 μA) flows via the Zener diode 12 in said operating range. The resistance of the Zener diode 12 in the operating range 16, which is below a breakdown voltage U_{BR} for the Zener diode 12, is therefore so high that practically the whole charging current is routed via the battery cell 10 and charges it.

The breakdown voltage U_{BR} of the Zener diode 12 has been chosen such that it corresponds approximately to an overvoltage limit for the battery cell 14. At the breakdown voltage U_{BR} of the Zener diode 12, a current I₁ flows. In the further increase in the voltage (in FIG. 2 in the direction of the negative U[V] axis) the resistance of the Zener diode 12 falls exponentially as the voltage increases further. The lower the resistance of the Zener diode 12, the more current is routed via said Zener diode and the less current is available for continuing to charge the associated battery cell 10.

The current which flows through the Zener diode 12 rises abruptly when the breakdown voltage U_{BR} is exceeded, as a result of which at a voltage U₂ practically the whole charging current 1₂ is routed past to the battery cell 10 via the bypass circuit formed by the Zener diode 12, which means that the battery cell 10 is protected against an overvoltage.

In a discharge process, the resistance of the Zener diode 12 is so high in comparison with the internal resistance 14 of the battery cell 10 that a discharge current flows completely via the battery cell 10.

1. A battery system comprising:
a multiplicity of battery cells connected in series; and
an electrical component connected in parallel with at least one battery cell of the multiplicity of battery cells,
wherein a resistance of the electrical component decreases when a voltage across the electrical component and across the at least one battery cell of the multiplicity of battery cells exceeds a predetermined voltage threshold value.

2. The battery system as claimed in claim 1, wherein each of the multiplicity of battery cells includes a respective electrical component connected in parallel with it, the resistance of the respective electrical component decreases when a voltage across the respective electrical component and across the battery cell connected in parallel therewith exceeds the predetermined voltage threshold value.

3. The battery system as claimed in claim 1, wherein the resistance of the electrical component falls exponentially above the predetermined voltage threshold value as the voltage present rises.

4. The battery system as claimed in claim 1, wherein the electrical component is a Zener diode.

5. The battery system as claimed in claim 1, wherein the electrical component is a suppressor diode.

6. The battery system as claimed in claim 1, wherein the electrical component is a metal oxide varistor.

7. A motor vehicle having comprising:
a battery system, including (i) a multiplicity of battery cells connected in series, and (ii) an electrical component connected in parallel with at least one battery cell of the multiplicity of battery cells; and
a drive system,
wherein a resistance of the electrical component decreases when a voltage across the electrical component and across the at least one battery cell of the multiplicity of battery cells exceeds a predetermined voltage threshold value, and
wherein the battery system is connected to the drive system of the motor vehicle.

8. A method for charging a multiplicity of battery cells connected in series, comprising:
supplying the multiplicity of battery cells connected in series with a charging current during a charging process;
suppressing a current flowing through one battery cell of the multiplicity of battery cells when a voltage across the one battery cell exceeds a predetermined voltage threshold value; and
decreasing a resistance of an electrical component connected in parallel with the one battery cell when the voltage threshold value is exceeded
wherein in response to the decreasing the resistance of the electrical component some of the charging current flows through the electrical component.
